(19) United States
(12) Patent Application Publication
(10) Pub. No.: US 2012/0315823 A1
(43) Pub. Date: Dec. 13, 2012

(54) TOY GUN FOR PRESSURIZED CANS

(76) Inventor: Steven Brzezinski, Massapequa, NY (US)

(21) Appl. No.: 13/157,951

(22) Filed: Jun. 10, 2011

(51) Int. Cl. A63H 33/30; B05B 9/01

(52) U.S. Cl. 446/473; 239/211; 239/302

(57) ABSTRACT

A toy gun for pressurized cans includes a body resembling a gun with a barrel; an adapter that retains the can; a trigger; a spray actuator head that, when the trigger is pulled, presses upon a valve assembly of the can so that the can discharges into the spray actuator head; a flair on the adapter to help accept the can and guide the valve assembly to the spray actuator head; and an extension tube that receives the discharge from the spray actuator head, transports the discharge through the barrel, and disperses the discharge out of the body. The toy gun may include an adapter on the bottom for shaving cream cans or on the top for whipped cream cans.

### BACKGROUND OF THE INVENTION

The present invention generally relates to toys and more specifically to a toy gun for pressurized cans.

Pressurized cans, such as for shaving cream or whipped cream, generally have an actuator head or valve nozzle that fits over the end of a short, stiff actuator tube or valve assembly male fitting. When the actuator head is pressed down onto the actuator tube, the tube is pressed down into the can, and the can discharges its contents through the tube and into the nozzle.

Manufactures of shaving cream may have removed the alcohol from their formulas in order to make a safe practice. However, kids may modify the standard valve nozzle using a cigarette lighter to melt the nozzle tip. They may melt the tip and close or reduce the orifice, thus creating more pressure to discharge the shaving cream in a stream.

Many kids on Halloween like to play with shaving cream and have shaving cream fights. It would be desirable to avoid the unsafe practice of using heat or fire to alter the nozzle.

It would be desirable to have a safe toy gun that snaps onto pressurized cans such as whipped cream cans or shaving cream cans.

### SUMMARY OF THE INVENTION

In one aspect of the present invention, a device for a pressurized can having a valve assembly to discharge the can's contents when pressed includes a body with a barrel; an adapter that retains the can; a spray actuator head that engages with the valve assembly and receives the can's discharge; a trigger that, when pulled, presses upon the spray actuator head so that the spray actuator head presses upon the valve assembly, thereby causing the valve assembly to discharge into the spray actuator head; and an extension tube that receives the discharge from the spray actuator head, transports the discharge through the barrel, and disperses the discharge out of the body.

In another aspect of the present invention, a toy for a pressurized can includes a body resembling a gun with a barrel; an adapter that retains the can; a trigger; a spray actuator head that, when the trigger is pulled, presses upon a valve assembly of the can so that the can discharges into the spray actuator head; a flair on the adapter to help accept the can and guide the valve assembly to the spray actuator head; and an extension tube that receives the discharge from the spray actuator head, transports the discharge through the barrel, and disperses the discharge out of the body.

In yet another aspect of the present invention, a toy to be utilized with a pressurized can having an actuator and a dispensing valve includes a body having two halves that snap together to resemble a toy gun having a barrel; an adapter that, when both halves are snapped together, accepts the dispensing valve of the pressurized can, and locks to the top of the can so as to support the can; a trigger which, when depressed, pushes on the actuator of the pressurized can; and a spray nozzle having substantially the same diameter as the diameter of the dispensing valve of the pressurized can, the spray nozzle fixed to the body and centered within the adapter, the spray nozzle having an extension tube that enables the contents of the pressurized can to travel through the barrel of the toy gun, the spray nozzle terminating with a small hole enabling the contents of the can to be dispersed from the can.

### BRIEF DESCRIPTION OF THE DRAWINGS

FIG. 1 is a side view of an embodiment of the present invention;

FIG. 2 is an underside view of the embodiment of FIG. 1;

FIG. 3 is an underside view of a spray valve actuator according to the embodiment of FIG. 1;

FIG. 4 is a perspective view of the spray valve actuator of FIG. 3;

FIG. 5 is a side view of a top-mounted embodiment of the present invention;

FIG. 6 is a side view of a side-mounted embodiment of the present invention; and

FIG. 7 is a side view of a two-can embodiment of the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

The present invention relates to a toy gun that snaps on top of a standard pressurized shaving cream can or whipped cream can. An embodiment of the invention may look like a toy hand gun with a pistol grip and an extended barrel.

An embodiment of the present invention may discharge its contents in a small powerful stream, providing accuracy and fun. A toy gun may snap on top of a standard pressurized shaving cream can or whipped cream can. Embodiments of the invention could be used as a novelty product or toy.

Embodiments may include a device that is activated like a hand-gun, and the contents are sprayed in a stream. A user might remove the standard shaving cream or whipped cream nozzle and insert the can adapter into the can's valve, on top of the can, and snap down the toy gun cream sprayer. The trigger may be activated like a hand-gun and the contents may be sprayed in a stream.

An embodiment of the invention may resemble a toy gun, and could be substantially made of injection mold plastic. The size of the can could be, for example, from 8 inches to 24 inches in length, and the weight could be 25 grams to 100 grams. Colors could be randomly selected, or provided in a variety of colors.

An embodiment of a toy gun body and assembly may include a combined handle, actuating device and spray nozzle that snaps onto a pressurized dispenser of shaving or other cream.

Embodiments of a toy gun base may have two halves that snap together to resemble a toy gun. The body may be constructed utilizing a two-part plastics mould, to provide matching components with co-operating portions that are secured together by snap engagement. An embodiment of a gun may have a molded adapter that, when both halves are folded and closed or snapped together, form a circular adapter that can slip inside a standard shaving cream or whipped cream can's standard dispensing valve and lock to the can top. This slip fit adapter locks to the top of the can with the valve enabling the gun to support the can.

Embodiments of a molder trigger could be manufactured separately from injection mold plastic, enabling the trigger to push onto an actuator spray nozzle. The trigger could be inserted inside the toy gun and act as a lever on a plastic molded pivot pin. When the trigger is pulled, the trigger would push down on the actuator spray nozzle of the shaving cream or whipped cream can.

An embodiment of a spray nozzle may be comprised of injection mold plastic. A spray nozzle may be manufactured to have the proper diameter of the shaving cream can whipped cream can standard dispensing valve. A nozzle could also have pivot pins manufactured on either side of the nozzle head in order to hold it into the toy gun assembly. The placement of this nozzle could be centered within the molded can adapter.

The gun assembly may have slotted holes on either side of the toy gun base. These slots may be the manufactured to the specification of the pins that are located on the spray nozzle. The spray nozzle may have an extension tube that enables the cream to travel through the barrel of the gun. The end of the tube may have a hole enabling the cream to be dispersed from the can. This hole may have a small diameter, enabling enough pressure from the can to be dispersed at a distance.

An embodiment of the invention may have a molded adapter extension having a precise diameter and lip or edge, to slip onto the can's assembly and to physically snap in and lock the can onto the base. Embodiments may have a diameter of approximately 1″ where both the sides are shaved about 0.16″ to facilitate snapping on to a can, so as to resemble an oval shape.

An embodiment if the invention may have a trigger pivot component to depress the spray nozzle and discharge the can's contents. This trigger component may have a molded plastic spring-like curved lever in order to provide the spring-like action on the trigger to depress the nozzle and return to its normal position.

An embodiment if the invention may have a spray nozzle with molded pins on either side of the spray nozzle head. These two plastic pins may act as a retainer and a guide to keep the nozzle in place when the base is snapped on to the can. This may also create a dual action so that the gun connects to the can while the nozzle slips over the valve stem.

The spray nozzle may also have an extension tube with a length depending upon the configuration and profile of the toy gun. The extension tube may have a spray tip and the spray tip may have a tiny orifice in order to create increased pressure and discharge the can's contents.

Embodiments of the invention may be lightweight and resemble a toy. Embodiments may come in a variety of colors.

An embodiment of a toy gun may include a base, a trigger or actuator, a spray nozzle, and a spray end.

An embodiment of a base toy gun component may resemble a toy hand gun with a pistol grip with an extended barrel. A base may be manufactured from a single injection mold unit. At the bottom or top, the gun base may have a molded value adapter extension. This extended adapter may be a molded part of the base and have the proper diameter to slip inside of the can's valve to lock the can to the base of the gun.

An embodiment of a trigger or actuator may pivot on a plastic molded pin within the base of the gun. Depressing or pulling the trigger would cause the actuator to push on an integrated spray nozzle. The trigger or actuator may also be molded with a plastic reflex spring, enabling the trigger to spring back after it is depressed for activation.

An embodiment of a spray nozzle may be manufactured from plastic with two pivot pins on either side of the head of the molded spray nozzle. The nozzle may have an extension tube with a plastic spray end. The spray end may be made from metal or plastic.

An embodiment of a spray end may include a small plastic adapter end to the plastic tube to narrow the flow of discharge from the can. This end could be inserted into the tube and would have a small hole that would enable the can of cream to be discharged with velocity and accuracy.

An embodiment of a trigger or actuator may be placed within the base of a gun, combined with an integrated nozzle assembly, which may enable a toy gun to be snapped on and used on a shaving cream or whipped cream can. By removing a nozzle that is included with the can and snapping on this toy guy sprayer, a cream sprayer may be used for targeting and spraying cream at further distance than that of a typical shaving cream or whipped cream can alone.

An embodiment of a toy gun may operate by removing the nozzle of a standard pressurized shaving cream can or whipped cream can and inserting a circular adapter extension that may either be molded on the bottom or top of the toy gun base. Embodiments of a toy gun may be manufactured with the can adapter on the bottom for shaving cream cans or on the top for whipped cream cans.

The placement of the can adapter extension may depend on the application. For example, a whipped cream can could be turned upside down in order for the contents to be discharged from the can. Conversely, a shaving cream can could remain upright or right side up in order for the contents to be discharged. In yet other embodiments, a can could be inserted into the back of toy gun. This embodiment may offer similar functionality to other embodiments, but with a different configuration. The embodiment might not have a mechanical lever actuating the can's valve, but would instead be enabled by a trigger actuating a liquid-like valve releasing the cream. In this case, the can could snap in and be engaged under pressure. The trigger could permit the cream to dispense like a faucet.

An embodiment of an adapter extension may include a can lock or mount to hold the can in place. Then can is connected to the base of the gun. The process of inserting and snapping on the can adapter extension may lock the can to the gun. Concurrently, the spray nozzle also fits over the can's discharge valve stem. The process of snapping on the can may also snap the spray nozzle over the can's valve stem. Therefore, when the trigger is engaged or pulled, the trigger component pivots downward and depresses the spray nozzle that is retained within the toy gun's base unit. The spray nozzle may be retained within the gun by the two plastic molded pins on either side of the plastic spray nozzle. The spray nozzle may be able to move freely up and down with a spring-like action in order to start and stop the discharge of the can's contents.

Embodiments may include two slotted holes on either side of the toy gun's base, above the can adapter extension. Slotted holes may be manufactured during the injection mold process, and may be located on either side of where the spray nozzle must be retained in order to fit on the can valve stem when the gun is locked to the can by the can adapter extension. This may enable the spray nozzle to have mobility and to move upward and downward.

An embodiment of the invention may be manufactured using standard plastic injection mold process of each the component and assembled by hand.

Other embodiments may be used for other applications offering the user a directional application of other spray can products that use nozzles that slip on to a can's valve stem. A barrel may be useful in a point and shoot application such as bug spray. Embodiments may help with proper direction of the spray contents.

Embodiments of this invention may be used for novelty and play, by directing the contents of spray can substances, providing better aim and view of the direction of the spray. Embodiments may include a barrel combined with the use of a trigger action and a simple snap on body. The can may have a value assembly that uses a valve stem that remains connected to the valve when the spray nozzle is removed.

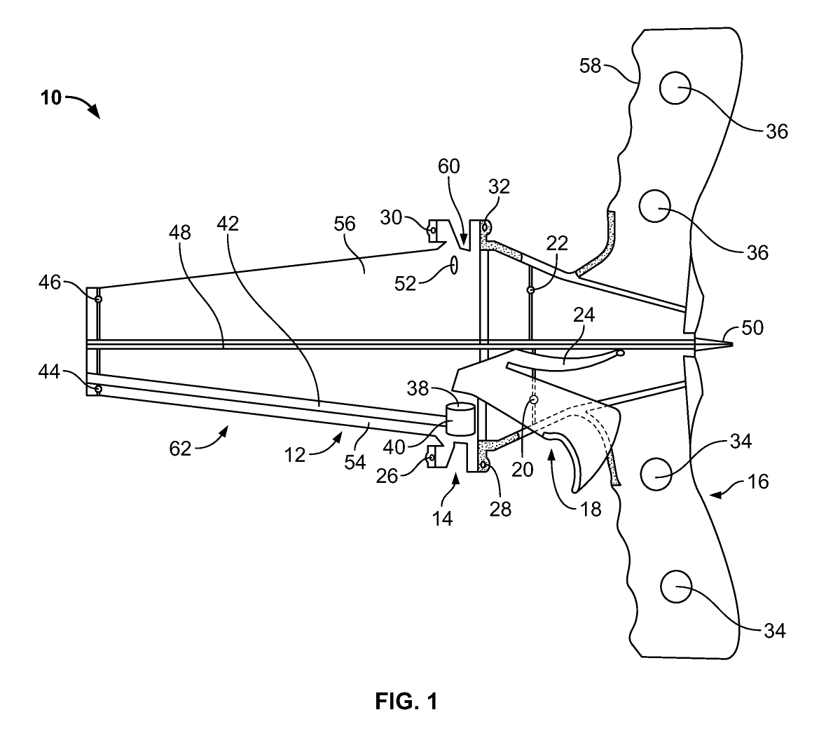

As depicted in FIG. 1, an embodiment of a toy gun 10 may include a gun body 12 which is shaped somewhat like a gun, having two halves. An embodiment may have a can adapter 14 for coupling to a pressurized dispenser can. A handle may be gripped in the hand of the user, and may include a handle grip or butt 16 with a hand grip 58. A trigger pull 18 may be actuated by the user's finger. A trigger pivot pin 20 may be formed on one side of the body 12, abutting a trigger pivot pin abutment 22 on the surface of in the other side. A reflex spring 24 may be molded as part of the trigger assembly, which may allow the trigger assembly to engage and disengage the spray actuator of the can with spring-like action. Molded nose pins 26 in the nose portion and molded tail pins 28 in the rear tail portion of one half of the body 12 may mate with nose pin holes 30 and tail pin holes 32 in the other half. Molded male body pins 34 and female jointing sockets 36 may secure both halves tightly together. A spray actuator head 38 may include a spray valve nozzle head made substantially of plastics such as polypropylene. Spray actuator pivot retention pins 40 may be molded into the spray actuator head 38, and may be made substantially of plastics such as polypropylene that enable the spray actuator head 38 to float within the body 12. A spray actuator extension tube 42 may extend down the barrel 62. Molded male body pins 44 and 54 and corresponding female body joining sockets 46 and 56 may secure both halves of the barrel tightly together. A molded hinge 48 may be used to close both halve of body together. A flat molded edge 50 may be used as a lever or blade to pop off and remove the spray nozzle that is normally supplied with the can. Oval shaped holes 52 may be molded into the body 12 on either side of the body located near the dispenser can adapter 14, to be used as a retention orifice for spray actuator head 38 and spray actuator pivot retention pins 40. The pins 40 located on either side of the spray actuator head 38 may be placed into holes 52 during assembly to retain the spray actuator head 38 and pivot retention pins 40 onto the dispenser can's valve assembly male fitting. The can adapter 14 may have a flair 60 to help insert the short tube of the can's valve assembly male fitting into the spray actuator head 38.

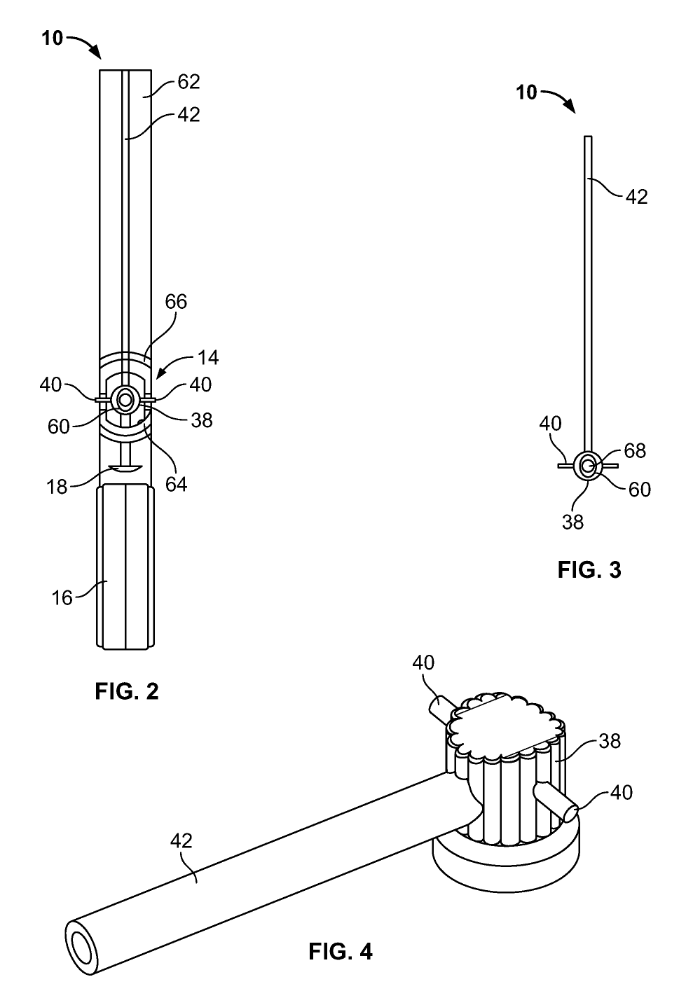

As depicted in FIG. 2, an embodiment of a toy gun 10 may include the underside of a hand grip 16 and barrel 62. Can adapter 14 may have a flair 60 in order to slip in the dispenser can male valve assembly. Spray actuator pivot retention pins 40 may be located on either side of the spray actuator head 38. The underside of the spray can adapter 14 may have a rear foot 64 and a front foot 66 that enables the toy gun 10 to be locked onto the top of the spray can dispenser. Spray Head 38 may slip onto the dispense can male valve assembly. Spray head extension tube 42 may extend the spray head so that the can's contents can be dispersed from the end of the gun barrel 62 when the pull trigger 18 is pulled.

As depicted in FIG. 3, an embodiment of a toy gun 10 may include a spray head extension tube 42, connected to the spray head 38 held by spray actuator pivot retention pins 40 on either side of the spray head 38. A spray head valve orifice 68 has a flair 60 to help spray head 38 slip onto the dispenser can male valve assembly and to simplify the slip-fit on to the dispenser can male valve assembly.

As depicted in FIG. 4, embodiments may include a spray actuator head 38, with pivot retention pins 40 on its sides and a spray actuator extension tube 42. When the actuator head 38 is pressed down onto the actuator tube of the pressured can, the can discharges its contents into the nozzle head 38 and then through the extension tube 42.

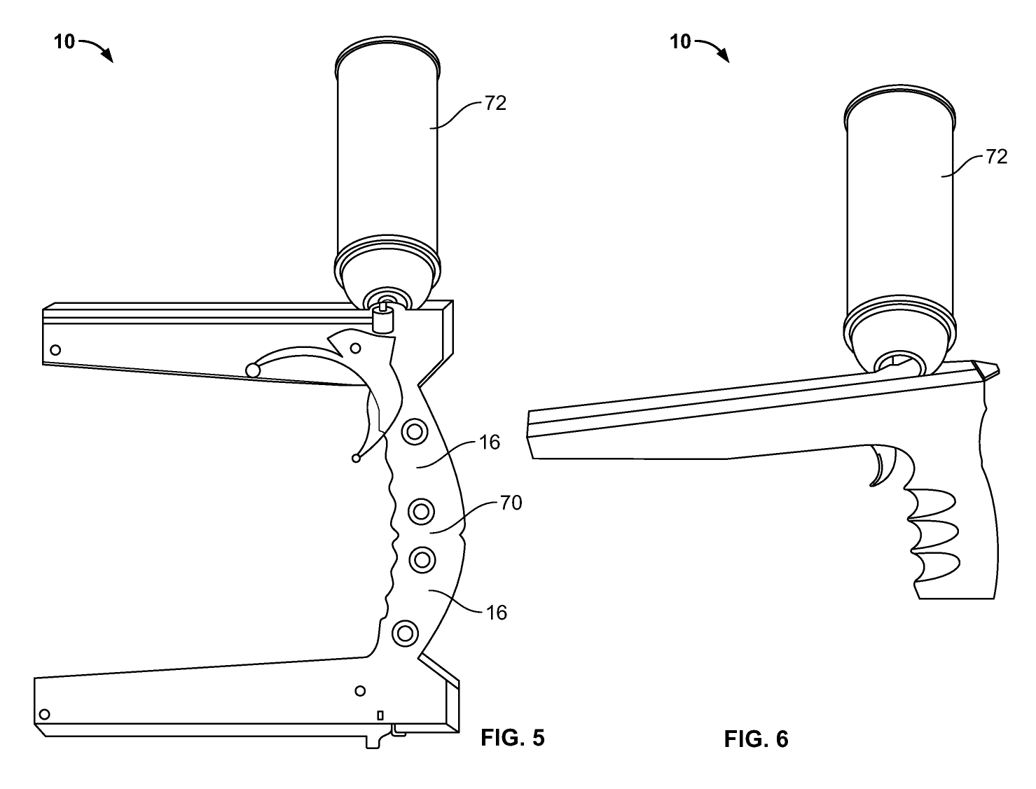

As depicted in FIG. 5, and embodiment of a toy gun 10 may have a hinge 70 on the handle 16, rather than the top of the barrel. This may allow a pressurized can 72 to be attached to the top of the gun 10, rather than the bottom.

As depicted in FIG. 6, an embodiment of a toy gun 10 may allow a pressurized can 72 to be attached to a side of the gun 10. Embodiments where the can attaches to the side may have a spray actuator head redirects the discharge, so that the extension tube will disperse the discharge out of the barrel. In another embodiment, the can may attach behind the rear of the can, so that the can may be attached in a sideways orientation behind the body 1

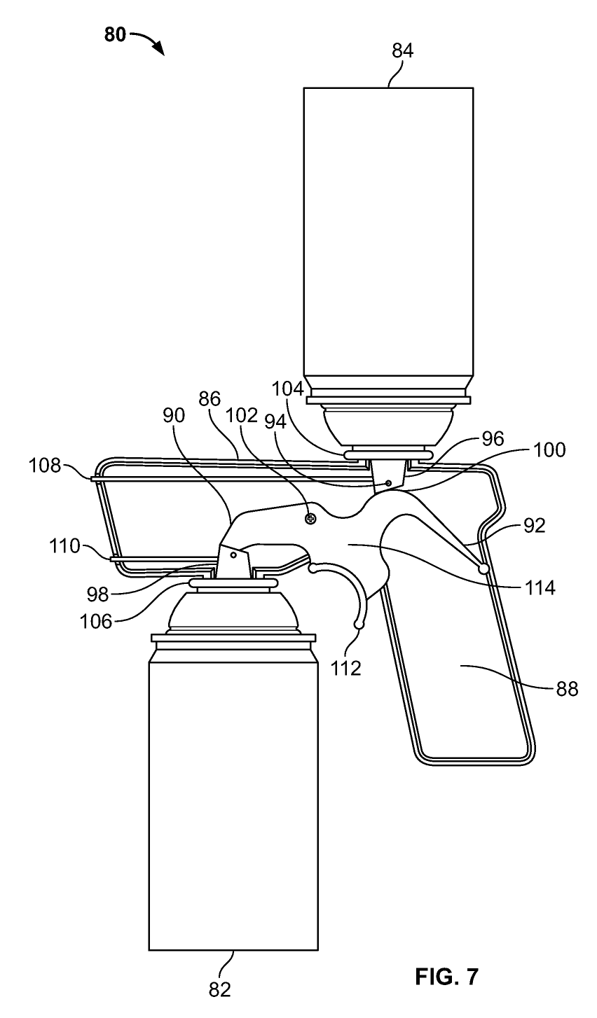

As depicted in FIG. 7, an alternate embodiment of a toy gun 80 may connect below the body to a lower can 82, held by a lower can coupling 106, or above the body to an upper can 84, held by an upper can coupling 104. The embodiment may have a gun barrel 86 and a gun handle 88. A single trigger 112 may operate an actuator 114 that has both a lower can actuator arm 90, which presses on a lower actuator spray head 98 that sprays into a lower spray outlet 108, and an upper can actuator arm 100, which presses on an upper actuator spray head 96 that sprays into an upper spray outlet 110. Retention pin slots 94 may retain the spray heads. An actuator pivot pin 102 and a trigger return spring lever 92 may be used to hold the trigger 112 and actuators.

An embodiment may include a toy to be utilized with a pressurized can having an actuator and a dispensing valve, the toy comprising: a base having two halves that snap together to resemble a toy gun having a barrel; an adapter that, when both halves are snapped together, accepts the dispensing valve of the pressurized can, and locks to the top of the can so as to support the can; a trigger which, when depressed, pushes on the actuator of the pressurized can; a spray nozzle having substantially the same diameter as the diameter of the dispensing valve of the pressurized can, the spray nozzle fixed to the base and centered within the adapter, the spray nozzle having an extension tube that enables the contents of the pressurized can to travel through the barrel of the toy gun, the spray nozzle terminating with a small hole enabling the contents of the can to be dispersed from the can.

I claim:

1. A device for a pressurized can having a valve assembly to discharge the can's contents when pressed, the device comprising:
a body with a barrel;
an adapter that retains the can;
a spray actuator head that engages with the valve assembly and receives the can's discharge;
a trigger that, when pulled, presses upon the spray actuator head so that the spray actuator head presses upon the valve assembly, thereby causing the valve assembly to discharge into the spray actuator head; and
an extension tube that receives the discharge from the spray actuator head, transports the discharge through the barrel, and disperses the discharge out of the body.

2. The device of claim 1, wherein the valve assembly includes a stiff tube, and the spray actuator head depresses the stiff tube into the can, thereby causing the valve assembly to discharge through the stiff tube into the spray actuator head.

3. The device of claim 1, further comprising a spray tip at an end of extension tube that narrows the flow of discharge.

4. The device of claim 1, further comprising a flair on the adapter to help accept the can and guide the valve assembly to the spray actuator head.

5. The device of claim 1, wherein the spray actuator head redirects the discharge, so that the can may be attached in an upright orientation below the body and the extension tube will disperse the discharge out of the barrel.

6. The device of claim 1, wherein the spray actuator head redirects the discharge, so that the can may be attached in a downward orientation above the body and the extension tube will disperse the discharge out of the barrel.

7. The device of claim 1, wherein the spray actuator head generally passes the discharge straight through, so that the can may be attached in a sideways orientation behind the body and the extension tube will disperse the discharge out of the barrel.

8. The device of claim 1, wherein the trigger pivots when pulled, thereby acting as a lever to press the spray actuator head toward the can.

9. The device of claim 1, wherein the trigger is molded with a reflex spring.

10. The device of claim 1, further comprising a pivot retention pin to retain the spray actuator head within the body.

11. The device of claim 1, wherein the body resembles a toy gun.

12. The device of claim 1, wherein the body has two halves that snap together to accept and retain the can.

13. A toy for a pressurized can:
a body resembling a gun with a barrel;
an adapter that retains the can;
a trigger;
a spray actuator head that, when the trigger is pulled, presses upon a valve assembly of the can so that the can discharges into the spray actuator head;
a flair on the adapter to help accept the can and guide the valve assembly to the spray actuator head; and
an extension tube that receives the discharge from the spray actuator head, transports the discharge through the barrel, and disperses the discharge out of the body.

14. The toy of claim 13, further comprising:
a second adapter adapted to retain the can and a second spray actuator head, the first adapter underneath the body and adapted to retain the can in an upright orientation, the second adapter above the body and adapted to retain the can in a downward orientation;
wherein, when the trigger is pulled, the spray head actuators press upon both valve assemblies so that the can may be utilized in either adapter.

15. A toy to be utilized with a pressurized can having an actuator and a dispensing valve, the toy comprising:
a body having two halves that snap together to resemble a toy gun having a barrel;
an adapter that, when both halves are snapped together, accepts the dispensing valve of the pressurized can, and locks to the top of the can so as to support the can;
a trigger which, when depressed, pushes on the actuator of the pressurized can; and
a spray nozzle having substantially the same diameter as the diameter of the dispensing valve of the pressurized can, the spray nozzle fixed to the body and centered within the adapter, the spray nozzle having an extension tube that enables the contents of the pressurized can to travel through the barrel of the toy gun, the spray nozzle terminating with a small hole enabling the contents of the can to be dispersed from the can.
